(19) United States
(12) Patent Application Publication
(10) Pub. No.: US 2010/0031140 A1
(43) Pub. Date: Feb. 4, 2010

(54) Verifying An Electronic Document

(76) Inventor: Fred A. Cummins, Pinckney, MI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/184,732

(22) Filed: Aug. 1, 2008

(51) Int. Cl. G06F 17/00

(52) U.S. Cl. 715/236; 715/234

(57) ABSTRACT

Systems, methods, and apparatus, including software tangibly stored on a computer readable medium, involve verifying an electronic document. A display document is generated based on a content document and a transformation document. The content document includes content data, and the transformation document includes format data. The display document includes information adapted to generate a graphical representation of the content data formatted according to the format data. A digital signature is generated using data from the content document and the transformation document. The digital signature is stored. The digital signature may be used, for example, to confirm that a signer has reviewed and/or endorsed a display document generated based on the content document and the transformation document.

### BACKGROUND

This description relates to verifying an electronic document. A digital signature can be applied to an electronic document to establish validity or authenticity of the electronic document, to enforce accountability of an originator and/or endorser of the electronic document, and/or for other purposes. For example, a digital signature can be applied to an electronic document based on a signer's approval of the electronic document. The digital signature can be authenticated, for example at a later time and/or by a recipient, to verify the signer's approval of the document. In some cases, a digital signature is generated and/or authenticated based on cryptographic techniques. For example, a digital signature may be generated and/or authenticated based on a public key, a private key, a certificate, and/or other cryptographic elements.

### SUMMARY

In one general aspect, a display document is generated based on a content document and a transformation document. The content document includes content data, and the transformation document includes format data. The display document includes information adapted to generate a graphical representation of the content data formatted according to the format data. A digital signature is generated using data from the content document and the transformation document. The digital signature is stored.

Implementations can include one more of the following features. The content data is modified, and the content document is updated based on the modification of the content data. The digital signature is generated based on the updated content document and the transformation document. The graphical representation of the content data formatted according to the format data is generated and presented to a user. The format data relates to a font size, a font style, a font color, a font position, and/or a font language. Generating the digital signature includes calculating a hash value based at least in part on the content document. Generating the digital signature includes generating an encrypted hash value based at least in part on the calculated hash value. A decrypted hash value is generated based at least in part on the encrypted hash value. A verification hash value is calculated based at least in part on the content document. The content document is verified based on a comparison of the verification hash value and the decrypted hash value. The encrypted hash value is generated based on a private key and the decrypted hash value is generated based on a public key associated with the private key. Generating the digital signature includes calculating a hash value based at least in part on an identification of the transformation document and/or includes modifying the content document to include an identification of the transformation document and generating the digital signature based on the modified content document. The digital signature is generated based on the content data and the format data. The content document is modified to include the digital signature, and the modified content document is transmitted over a communication interface. The content document includes an extensible markup language (XML) document and the transformation document includes an extensible stylesheet language transformation (XSLT) document. The display document includes at least one of a portable document file (PDF) document or a hypertext markup language (HTML) document. The format data includes format data for presenting information in a first language. A second display document is generated, and the second display document includes information adapted to present the content data according to additional format data. The additional format data includes format data for presenting information in a second language. The additional format data is included in the transformation document, or the format data is included in a different transformation document. The described techniques can be implemented in methods, systems, apparatus, computer program products, or otherwise, tangibly stored on a computer readable medium as instructions operable to cause programmable processor to perform actions.

The details of one or more implementations are set forth in the accompanying drawings and the description below. Other features will be apparent from the description and drawings, and from the claims.

### DESCRIPTION OF DRAWINGS

FIG. 1 is a block diagram illustrating an example computing system.

FIG. 2 is a signaling and flow diagram illustrating an example process for verifying an electronic document.

FIG. 3A is a flow chart illustrating an example process for verifying an electronic document.

FIG. 3B is a flow chart illustrating an example process for generating a digital signature.

FIG. 3C is a flow chart illustrating an example process for verifying an electronic document based on a digital signature.

FIG. 4 is a block diagram illustrating an example data processing system.

Like reference symbols in the various drawings indicate like elements.

### DETAILED DESCRIPTION

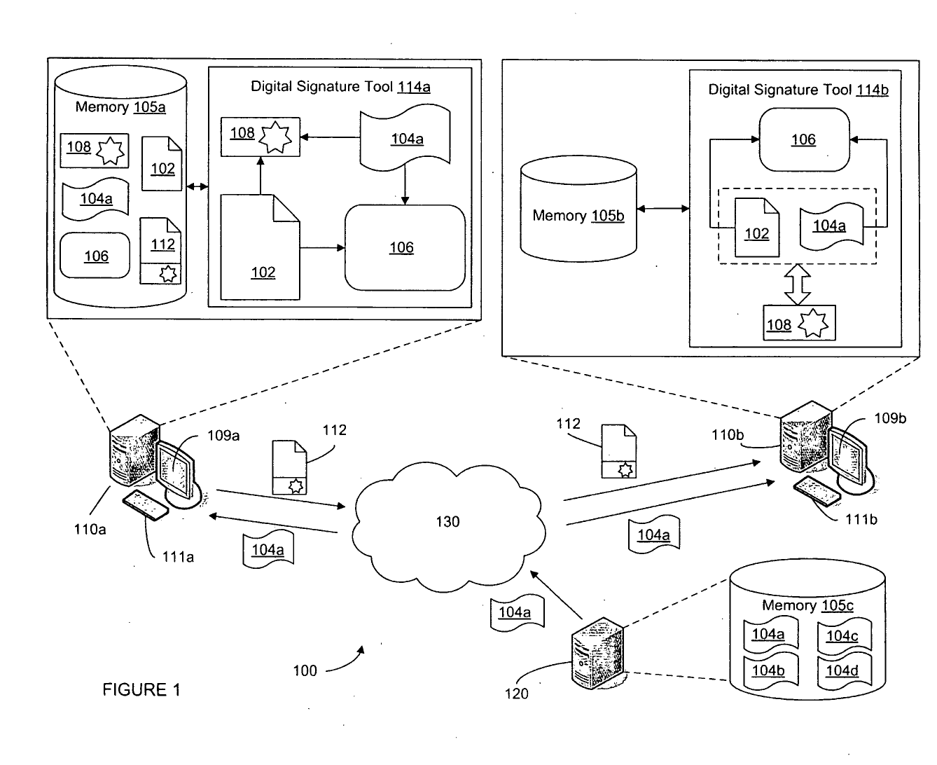

FIG. 1 is a block diagram illustrating an example computing system 100 that can be used to validate an electronic document using a digital signature. The system 100 can generate a display document based on a content document and a transformation document, and a graphical display can be generated based on the display document. The graphical display can be presented to a user, for example, for the user to review and/or approve. The graphical representation includes content information from the content document formatted according to the transformation document. As an example, the content document may include details of a purchase order (e.g., a part number, an order quantity, a date, a purchaser's name, a delivery location, and/or others), and the transformation document may specify the appearance, layout, and/or other format data for the purchase order (e.g., font size, font style, text position, currency type, language, and/or others). Based on a signing entity's approval of the graphical display, a digital signature can be generated based on the content document and the transformation document, and the digital signature can be included in or attached to the content document. When the signed content document is verified using the digital signature (e.g., at a later time and/or by a recipient), the digital signature can be used to ensure that the proper transformation document is used to generate a display document representing the approved graphical representation. Neither the approved display document nor the graphical representation needs to be stored and/or transmitted along with the digital signature to ensure that the approved graphical representation is generated when the digital signature is authenticated. In some cases, the transformation document need not be stored and/or transmitted along with the digital signature. For example, the transformation document may be accessed from a transformation document repository and/or a local memory based on an identification of the transformation document included in the signed electronic document. Thus, in some implementations, the signed document is stored and/or transmitted more efficiently. For example, the signed content document may consume less memory when stored, and/or the signed content document may consume less network volume when transmitted.

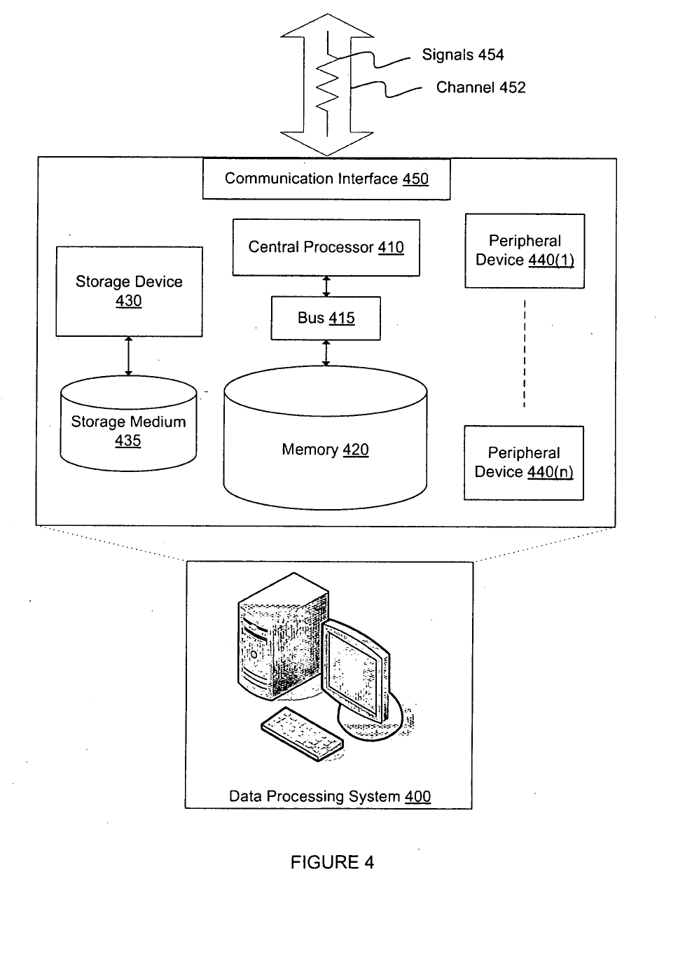

The example computing system 100 includes a first data processing system 110a communicably coupled by a network 130 to a second data processing system 110b. The first and second data processing systems 110a and 110b are each communicably coupled by the network 130 to a third data processing system 120. In the illustrated example, the first data processing system 110a includes a memory 105a, a digital signature tool 114a, a keyboard 111a, a monitor 109a, and other components; the second data processing system 110b includes a memory 105b, a digital signature tool 114b, a keyboard 111b, a monitor 109b, and other components; and the third data processing system 120 includes a memory 105c and other components. Additional aspects and features that may be included in one or more of the data processing systems 110a, 110b, and/or 120 are described with respect to the example data processing system 400 illustrated in FIG. 4. The network 130 may include one or more wired and/or wireless networks. For example, the network 130 may include a local area network (LAN), a wide area network (WAN), a metropolitan area network (MAN), the Internet, and/or any other type of communication network that allows the data processing systems 110a, 110b, and/or 120 to communicate.

The digital signature tool 114a may be implemented as software, hardware and/or firmware. The digital signature tool 114a can be implemented as a software application or a module of a software application that includes instructions executed by a processor, for example, a processor of the data processing system 110a. The digital signature tool 114a generates a display document 106 based on a content document 102 and a transformation document 104a. The display document 106 can generate a graphical representation of content data from the content document 102 formatted according to format data in the transformation document 104a. In some cases, the digital signature tool 114a generates the digital signature by accessing a separate tool. For example, the digital signature tool 114a may invoke a separate digital signature software application to generate the digital signature. In some cases, the digital signature tool 114a provides data (e.g., the content document 102, the content data, the transformation document 104a, the format data, the display document 106, and/or other data) to the separate digital signature software application, and in response, the separate digital signature software application provides the digital signature 108 and/or a signed document 112 to the digital signature tool 114a. Similarly, in some cases, the digital signature tool 114a generates the display document 106 by accessing a separate tool. For example, the digital signature tool 114a may invoke a separate transformation software application to generate the display document 106. Thus, the digital signature tool 114a may be implemented as a software, hardware, or firmware module that accesses other tools to ensure that the digital signature is applied to the content document 102 and/or the transformation document 104a used to generate the display document 106.

In one example, the content document 102 is an extensible markup language (XML) document, and the transformation document 104a is an extensible style sheet language transformation (XSLT) document. The XML document and the XSLT document can be used to generate the display document 106, which may include, for example, a hypertext markup language (HTML) document. When the HTML document is loaded by a web browser, the HTML document generates a graphical representation of the content of the XML document according to formatting information in the XSLT document.

The graphical representation can be displayed on the monitor 109a, for example, to a user for review and/or approval. The user may modify the content document 102 based on the displayed graphical representation, and an updated display document 106 may be generated to present an updated graphical representation to the user. For example, the user may enter data through a user interface, such as the keyboard 111a, a mouse, a touch screen, a microphone, and/or others. The user may indicate approval of the graphical representation, and a digital signature 108 may be generated based on the content document 102 and the transformation document 104a. For example, the content document can be modified to include an identification of the transformation document 104, and the digital signature 108 may be generated based on the content document 102 that includes the identification of the transformation document 104a. The identification may include, for example, a memory location of the transformation document 104a, a pointer to a memory location, a uniform resource locator, a name of the transformation document 104a, and/or another type of identifier. In another example, the content document 102 can be modified to include all or part of the transformation document 104a, and the digital signature 108 can be generated based on the modified content document 102 that includes data from the transformation document 104a. In another example, the digital signature 108 can be generated based on two or more documents that include the content document 102 and the transformation document 104a. The digital signature 108 may be applied to one or more documents to generate a signed document 112. For example, the digital signature 108 may be attached to an XML content document 102 to generate a signed XML document 112. The digital signature 108 can be stored in the memory 105a. For example, the digital signature 108 can be stored as part of the signed document 112, and/or the digital signature 108 can be stored as a separate object in the memory 105a.

The memory 105a stores content documents, transformation documents, display documents, digital signatures, signed electronic documents, and other data. The illustrated content document 102 is an electronic document that includes content data. The content document 102 can include information to be approved and/or validated based on a digital signature. For example, the content information included in the content document 102 can include the details of a business proposal, terms of an agreement or a contract, a date, the text of a letter or memo, approval of disbursements, a part number, an order quantity, a price and/or other types of information. The content document 102 may be stored as multiple electronic documents or as part of a larger electronic document. The content document 102 can be a structured document with multiple data fields, tags, and/or environments. The content document 102 can include an XML document, a spreadsheet, a comma or tab delimited document, and/or other types of documents. The content data in the content document 102 can be included in the display document 106.

The illustrated transformation document 104a includes format data. The format data may specify the style, appearance, layout, and/or other aspects of the content information in the graphical representation generated by the display document 106. For example, the format data may specify the position of various data fields and/or objects in a graphical representation generated by the display document 106, regional and/or language data, font size, font position, date format, paper size, and/or other aspects. The transformation document 104a may be stored as multiple electronic documents or as part of a larger electronic document. The transformation document 104a can specify rules for displaying data fields and/or data environments in the content document 102. In some implementations, the transformation document 104a may specify rules for displaying data in the content document based on metadata that is also contained in the content document 102. The transformation document 104a may specify a language (e.g., English, Japanese, German, French, Spanish, and others) and/or a character set for presenting information, labels of various data fields, and/or other data. For example, if “purchase order number” is a data field in the content document 102, the transformation document 104a can specify rules for displaying data in the “purchase order number” field in a graphical representation. For example, if “sales tax” is a data field in the content document 102, the transformation document 104a can specify a currency type to be indicated for the field “sales tax” in a graphical representation. For example, if “date” is a data field in the content document 102, the transformation document 104a can specify a language for displaying the word “date” (e.g., “date” in English, “fecha” in Spanish, and/or others) and a format for displaying a date (e.g., month-day-year, day-month-year, and/or others). In some cases, multiple different transformation documents are available for use in the system 100. For example, a first transformation document 104a may include format data for; presenting information in a first language (e.g., English, French, etc.), and a second transformation document 104b may include format data for presenting information in a second language. The transformation document 104a can be an XSLT document. The transformation document 104a can include a style sheet written in a code language such as cascading style sheets (CSS), extensible style sheet language (XSL), or another type of code language.

The illustrated display document 106 is adapted to generate a graphical representation of the content data included in the content document 102. The graphical representation presents the content data according to the format data included in the transformation document 104a. The display document 106 may include markup language code for generating the graphical representation. For example, the display document 106 may include HTML code, and/or another type of code. The display document 106 may include graphics and/or image data. For example, the display document 106 may include portable document file (PDF) data, postscript (PS) data, pixel data, and/or compressed image data.

The illustrated digital signature 108 includes data for verifying an electronic document. For example, the digital signature 108 can be generated by a signer based on the signer's approval of an electronic document or to simply verify that the electronic document is a version that the signer has reviewed, and the digital signature 108 can be authenticated to verify the signer's approval or review of an electronic document. In some cases, the digital signature 108 is attached to the approved electronic document and/or other documents to generate a signed electronic document 112.

The digital signature 108 may include and/or refer to the transformation document 104a and/or other documents as attachments. The digital signature 108 can be generated based on a number of techniques. For example, the WS-Signature standard uses encryption keys. Encryption key techniques, such as the WS-Signature standard and others, may be based on asymmetric cryptography (e.g., RSA cryptography, and/or others). For example, an encryption key technique may include generating a public key, a private key, and/or a certificate. A signer can generate a digital signature using the private key, and a second party can authenticate the signature using the public key. In some cases, only a digital signature generated by the private key can be authenticated by the public key.

In some cases, the digital signature 108 is generated based on a hash value. A hashing algorithm may be used to generate the hash value based on a document to be signed. The hash value may be substantially unique to the document upon which the hash value is based. In some cases, if the document is modified even slightly, the hashing algorithm generates a different hash value. The hash value may be encrypted with a signer's private key. The encrypted hash value may be included with or attached to the document and serve as the digital signature 108. To authenticate the digital signature, the encrypted hash value may be decrypted using the signer's public key to generate a decrypted hash value, and the hashing algorithm may be used to generate a comparison hash value based on the document. The digital signature 108 is authenticated by comparing the decrypted hash value to the comparison hash value. If the decrypted hash value is the same as the comparison hash value, then the document can be reliably accepted as representing what was actually approved by the signer.

The signed electronic document 112 may include all or part of the content document 102 and/or an identification of the content document 102. The signed electronic document 112 may include all or part of the transformation document 104a and/or an identification of the transformation document 104a. The digital signature 108 may be included in the header or a different section of the signed document 112. The digital signature 108 may be attached to the signed document 112. The signed document 112 may be an XML document or a different type of document.

The signed document 112 may be transmitted over the network 130 to the data processing system 110b. The memory 105b of the data processing system 110b may store the content document 102, the transformation document 104, the display document 106, the digital signature 108, the signed electronic document 112, and/or other data. The digital signature tool 114b may authenticate the digital signature 108 included in the signed electronic document 112. The digital signature tool 114a may be implemented as software, hardware and/or firmware. The digital signature tool 114b can be implemented as a software application or a module of a software application that includes instructions executed by a processor, for example, a processor of the data processing system 110b. The digital signature tool 114b can access the content document 102 (and/or the content data from the content document 102) and the transformation document 104a (and/or the format data from the transformation document 104a). The digital signature tool 114b can generate the display document 106 based on the content document 102 and the transformation document 104a. Authentication of the digital signature 108 verifies that the approved display document 106 is generated based on the content document 102 and the transformation document 104a.

For example, the digital signature tool 114b may receive the signed document 112 that includes the content document 102. The content document 102 includes the digital signature 108 and an identification of the transformation document 104a. The digital signature is authenticated to verify that the signer of the document 112 approved a display document 106 that was generated based on the content document 102 and the transformation document 104a. The transformation document 104a is retrieved based on the identification (e.g., from a local or remote storage location), and the digital signature tool 114b generates the approved display document 106. The approved display document 106 generated by the digital signature tool 114b may then be used to generate a graphical representation of the content information formatted according to the transformation document 104a.

The data processing system 110a and/or the data processing system 110b may retrieve the transformation document 104a and/or other transformation documents from the data processing system 120. For example, the data processing system 120 may include a transformation document database or repository. The memory 105c can store one or more transformation documents and other data. In the illustrated example, the memory 105c stores four transformation documents: 104a, 104b, 104c, and 104d. The data processing system 120 may include additional memories and/or many additional transformation documents. A transformation document database or repository may be maintained by an enterprise. The database may include a number of standard and/or specialized transformation documents for generating standardized documents for use in the enterprise. The database may be maintained to ensure that the transformation documents remain unchanged. For example, in some cases, after a digital signature is applied to a document based on a transformation document 104a, it is important to maintain the transformation document 104a to allow the approved display document 106 to be regenerated at a later time. In some cases, a digital signature tool 114 modifies a transformation document 104, and the modified transformation document is transmitted to and stored by the data processing system 120.

Each of the transformation documents may be configured to present the same data in a different format. For example, the transformation document 104a may be configured to present a purchase order in English, and the transformation document 104b may be configured to present the purchase order in Japanese. Additionally or alternatively, each of the transformation documents may be configured to present different types of data. For example, the transformation document 104a may include format data for generating a contract, and the transformation document 104b may include format data for generating a business proposal.

Some or all of the components and/or functionality of one or more of the data processing systems 110a, 110b, and/or 120 may be incorporated into a single data processing system. The digital signature tools 114a and 114b may be included in the same data processing system. The memory 105c may be included in the same data processing system with one or both of the digital signature tools 114a and 114b.

Components and/or functionality described with regard to one of the data processing systems 110a, 110b, or 120 may be distributed over multiple data processing systems. The memory 105c may be implemented in two, three, or more database systems. Each of the digital signature tools 114a and 114b may be implemented in two, three, or more data processing systems.

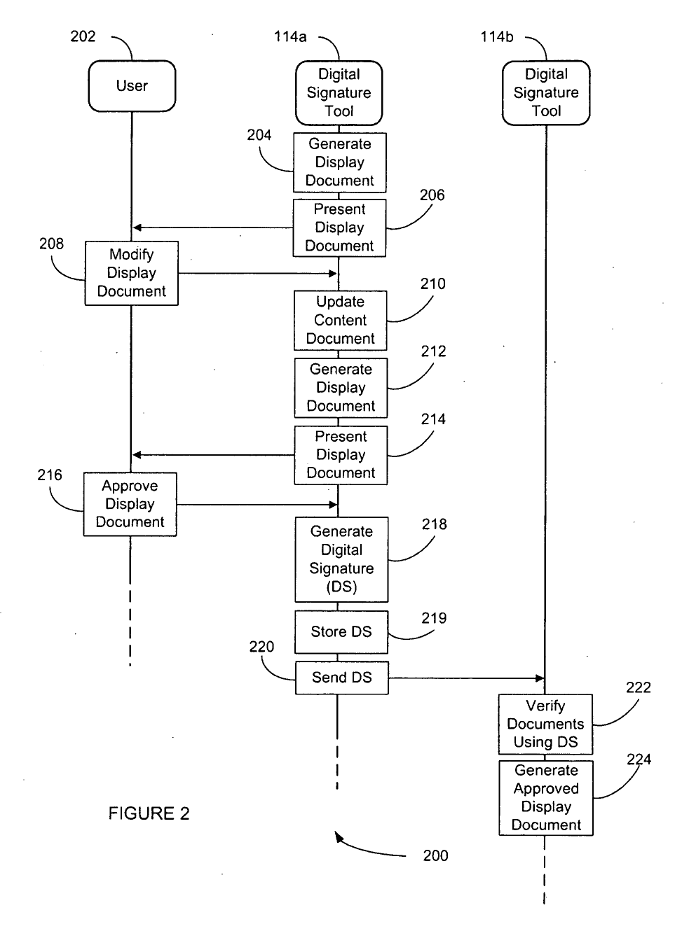

FIG. 2 is a flow chart illustrating an example process 200 for verifying an electronic document. The flow chart illustrates operations and communication among three entities: a user 202, a digital signature tool 114a, and a digital signature tool 114b. The user 202 can represent a human user, or the user 202 can represent one or more user interfaces (e.g., a screen, a mouse, a keyboard, a speaker, a microphone, a printer, and/or others) communicably coupled with the digital signature tool 114a. The digital signature tools 114a and 114b can be the digital signature tools 114a and 114b of FIG. 1. In some cases, the digital signature tools 114a and 114b represent two or more different software applications running on one, two, or more different data processing systems. In some cases, the digital signature tools 114a and 114b represent separate instances of one software application running on one, two, or more different data processing systems. In some cases, the digital signature tools 114a and 114b represent two or more different aspects of a single software application running on one, two, or more different data processing systems. The digital signature tool 114b may also present information to and receive information from the user 202 and/or a different user. In some implementations, the example process 200 includes the same, additional, and/or different operations in the same or a different order.

At 204, the digital signature tool 114a generates a display document. The display document is based on data associated with and/or included in a content document and a transformation document. The content document includes content data, and the transformation document includes format data. Data associated with the content document and the transformation document may include the content data, the format data, an identification of the transformation document, and/or other data. The display document can generate a graphical representation of the content data formatted according to the format data. For example, the display document may generate a display that includes text data from the content document, where the text data is presented in a format (e.g., font type, font face, font size, font color, font position, etc.) according to the transformation document. In some cases the transformation includes a style sheet. The display document can include HTML or another language interpretable by a web browser (e.g., Microsoft Internet Explorer, Mozilla Firefox, Safari, and/or others). In some cases, the display document includes a PDF document and/or another type of data.

At 206, the digital signature tool 114a presents the display document to the user 202. For example, the digital signature tool 114a may generate a graphical representation of the display document, and the graphical representation may be presented to a human user through a graphical user interface, through a printer, or through another medium. In some cases, a web browser reads the display document and generates the graphical representation. In some cases, a document reader software (e.g., Adobe Reader, Ghostscript, and/or another software) reads the display document and generates the graphical representation.

At 208, the user 202 indicates a modification of the display document. The user 202 communicates the modification to the digital signature tool 114a. The modification may include a revision or addition of text or other data in the content and/or display document, an insertion of a typed signature or a signature image, and the like. In some cases, the modification is communicated to the digital signature tool 114a automatically, for example, without prompting from a human user. For example, the modification may be communicated automatically by a server or a client based on a scheduled update, a detected spelling error, and/or other information.

At 210, the digital signature tool 114a updates the content document. For example, the content document may be updated based on the modification received at 208. At 212, the digital signature tool 114a generates an updated display document based on the updated content document and the transformation document. At 214, the digital signature tool 114a presents a graphical representation of the updated display document to the user 202. The graphical representation presented at 214 may include some or all of the modifications indicated by the user 202 at 208.

In some implementations, the operations 208, 210, 212, and 214 are each iterated a number of times, for example, until the user 202 is satisfied with the display document or until no further needed modifications are detected. In some implementations, the operations 208, 210, 212, and 214 are omitted, for example, if the user 202 is satisfied with the display document presented at 206.

At 216, the user 202 approves the display document. The user may send an indication of approval to the digital signature tool 114a. The user may indicate approval, for example, by a mouse click, by entering a password, and/or by another technique.

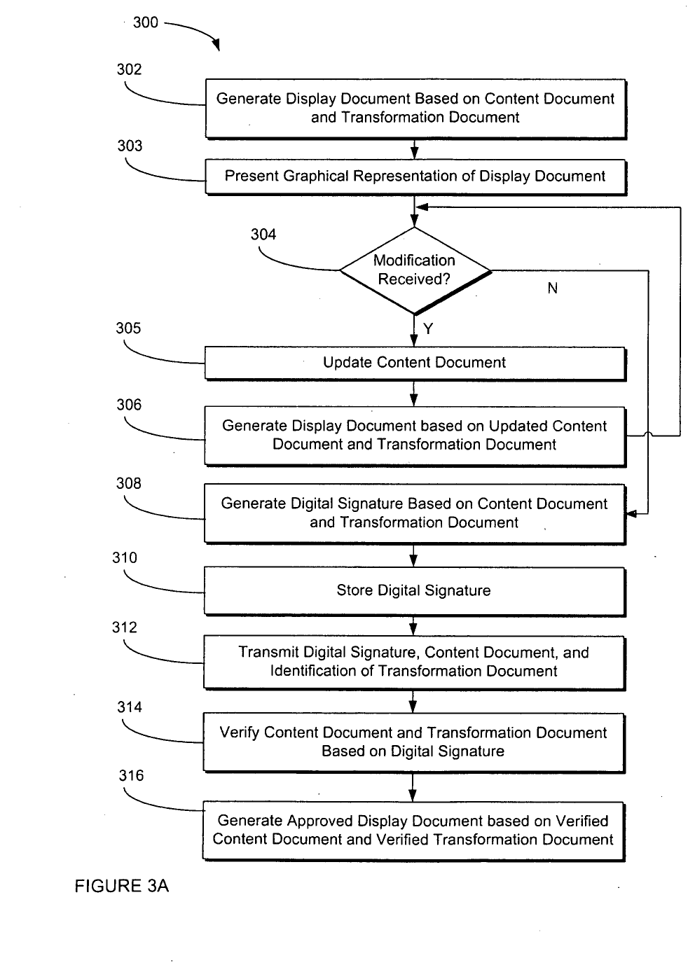

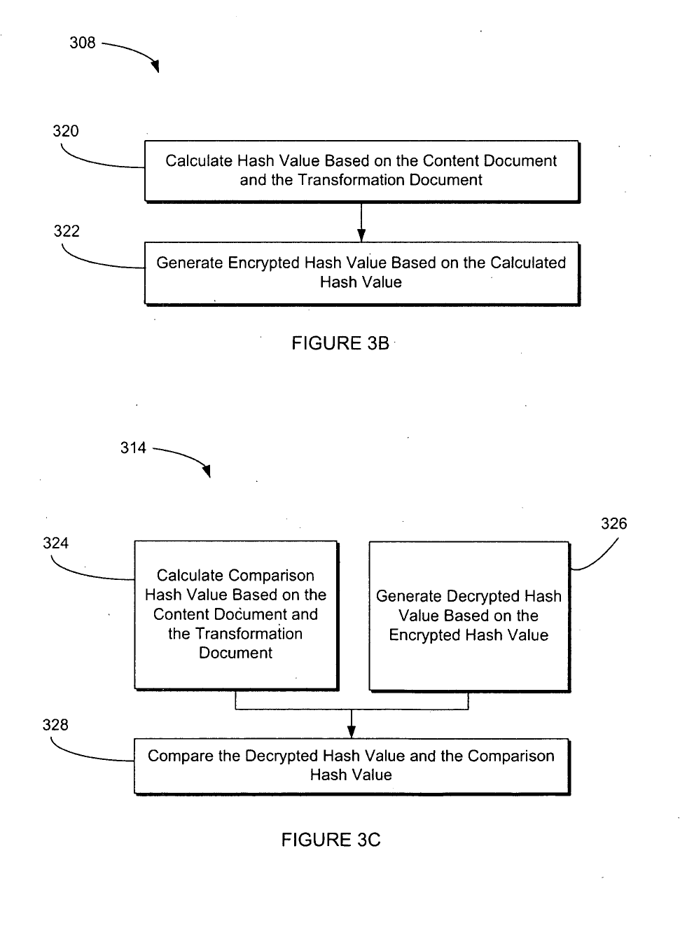

At 218, in response to the user approval, the digital signature tool 114a generates a digital signature based on the content document and the transformation document. The digital signature can be the digital signature 108 of FIG. 1. Many techniques may be used to generate a digital signature. An example process 308 for generating a digital signature is presented in FIG. 3B.

At 219, the digital signature is stored. For example, the digital signature may be stored in a machine-readable medium (e.g., a cache memory, a main memory, etc.) of a data processing system running one or both of the digital signature tools 114a and 114b. The digital signature may be stored in a machine-readable medium of a separate machine or on a removable storage medium.

At 220, the digital signature tool 114a sends the digital signature to the digital signature tool 114b. The digital signature tool 114a and the digital signature tool 114b may communicate directly, and/or the digital signature tool 114a and the digital signature tool 114b may communicate indirectly. The digital signature and/or a signed document may be stored locally and/or remotely by the digital signature tool 114a and retrieved by the digital signature tool 114b. In some cases, the digital signature tool 114a performs the operations described with respect to the digital signature tool 114b. At 222, the digital signature tool 114b verifies the content document and the transformation document using the digital signature. The documents may be validated by authenticating the digital signature. Many techniques may be used to authenticate a digital signature. An example process 314 for authenticating a digital signature is presented in FIG. 3B. Additional data, such as an encryption key or a certificate, may be received by the digital signature tool 114b to authenticate the digital signature.

At 224, the digital signature tool 114b may generate an approved display document based on the verified content document and transformation document. The approved display document may be used to generate a graphical representation of the approved display document, and the graphical representation may be presented to a user (e.g., the user 202 and/or a different user).

In some implementations, the digital signature tool 114b generates a display document based on the verified content document and a different transformation document (i.e., a transformation document other than the transformation document used to generate the display document at 204). For example, the digital signature tool 114b may verify the content document using a first transformation document and generate a display document based on a different transformation document. The first transformation document may include format data for presenting information in a first format (e.g., in a first language), and a second transformation document may include format data for presenting the information in a second format (e.g., in a second language). In some implementations, the digital signature tool 114b does not generate a display document based on the verified content document. In some implementations, the content document can be processed and verified (e.g., by a computer) without generating a display document. In such a case, it is possible to verify the content document based on the digital signature without necessarily generating a display document.

In some implementations, the content document includes multiple different sections. Each section may be generated and/or verified by different users, using different digital signature tools 114, at different times, and/or using different apparatus. A digital signature may be generated based on each of the different sections of the content document and/or based on the composite of all the sections of the content document. Each section may be associated with a different transformation document. For example, a first digital signature may be generated based on a first section of the content document and a first transformation document, and a second digital signature may be generated based on a second section of the content document and a second transformation document. The first and second digital signatures may be generated based on approval and/or review by the same user, two different users, an automated system, and/or others.

FIG. 3A is a flow chart illustrating an example process 300 for verifying an electronic document. In some implementations, the example process 300 includes the same, additional, and/or different operations in the same or a different order.

At 302, a display document is generated based on data associated with a content document and a transformation document. The content document includes content data, and the transformation document includes format data. The data associated with the content document and the transformation document may include the content data, the format data, an identification of the transformation document, and/or other data. The display document includes information adapted to generate a graphical representation of the content data formatted according to the format data. For example, the format data may relate to a font size, a font style, a font color, a font position, a font language, and/or other information; the content data may include one or more data fields and/or data environments; and the display document may be adapted to present data in each data field according to the format data. In some cases, the content document is an XML document, the transformation document is a style sheet document, and the display document is an HTML, PDF, or other type of document.

At 303, a graphical representation of the display document is generated, and the graphical representation may be presented to a user. The graphical representation may be an image, a graphical user interface, or another object. The graphical representation may be presented using a monitor, a printer, or another type of device.

At 304, modifications may be received based on the graphical representation of the display document. For example, the user may add, delete, and/or modify information included in the graphical representation. As another example, the modifications may be detected and/or communicated automatically.

If modifications are received at 304 based on the graphical representation, the content document is updated at 305. The content document can be updated to incorporate the received modifications. In some cases, in addition to or instead of updating the content document, the transformation document can be updated to incorporate the received modifications. At 306, an updated display document is generated based on the updated content document and the transformation document. The display document and/or the graphical representation may also be updated. After the updated display document is generated at 306, the process 300 returns to 304, where further updates may be received.

If no modifications are received at 304 based on the graphical representation of the content document (or in some cases, if no modifications are received at 304 based on the graphical representation of the updated content document), a digital signature is generated based on the content document and the transformation document at 308. Many techniques may be used to generate a digital signature. The digital signature may be generated based on a defined algorithm, such as an encryption key algorithm. An example process for generating a digital signature is provided in FIG. 3A. The digital signature may be generated based on all or part of the content document, the transformation document, and/or an identifier of the transformation document. A single digital signature may be generated based on the content document and the transformation document. In some cases, a first digital signature is generated based on the content document and a second digital signature is generated based on the transformation document. In some cases, the content document is modified to include an identification of the transformation document, and the digital signature is generated based on the modified content document.

At 310, the digital signature is stored. For example, the digital signature may be stored in a machine-readable medium of a computer, a database, a server, or another type of data processing system. The digital signature may be stored alone, included in the content document (e.g., in a header), attached to the content document, and/or stored in a different manner.

At 312, the digital signature or signatures, the content document, and an identification of the transformation document are transmitted. For example, the digital signature, the content document, and the identification of the transformation document may be transmitted over a network to a database server, an e-mail server, a web server, a personal computer, or any other data processing system. All or part of the content document may be transmitted. In addition to or instead of transmitting an identification of the transformation document, all or part of the transformation document itself may be transmitted. The digital signature and/or other transmitted data may be included in the content document, for example, in a header and/or a different section.

At 314, the content document and transformation document are verified based on the digital signature. In some cases, the content document and transformation document are verified by a digital signature tool that receives the documents transmitted at 312. Many techniques may be used to verify a digital signature. An example process 314 for verifying electronic documents is provided in FIG. 3B. The content document and transformation document may be verified based on authentication of the digital signature. For example, if the digital signature is found to be authentic, the documents may be considered to include content data and format data approved by the signer.

At 316, an approved display document is generated based on the verified content document and verified transformation document. The display document includes information adapted to generate a graphical representation of the content data formatted according to the format data. The display document may be the same as the display document generated at 302, or the display document may include the same information in a different type of document. For example, if the display document generated at 302 is an HTML document, the display document generated at 316 can be the HTML document or a PDF. In this example, the HTML and the PDF are adapted to generate the approved graphical representation.

FIG. 3B is a flow chart illustrating an example process 306 for generating a digital signature. In some implementations, the example process 306 includes the same, additional, and/or different operations in the same or a different order. In some cases, operations are implemented based on and/or to comply with the WS-Signature standard.

At 320, a hash value is calculated based on the content document and the transformation document. The hash value may be generated according to a hashing algorithm and based on the content document, the transformation document, an identification of the transformation document, and/or other data. Example algorithms for generating a hash value include Message Authentication Code (MAC), Cipher Block Chaining MAC, HMAC, CALG_HMAC, MD5 (developed by RSA Data Security, Inc.), Secure Hash Algorithm (developed by the National Institute of Standards and Technology and the National Security Agency), SSL3 Client Authorization Algorithm, keyed-hash algorithms, and others.

At 322, an encrypted hash value is generated based on the calculated hash value. The encrypted hash value may be generated based on a private key. The private key may be associated with a public key that can be used to authenticate the digital signature by decrypting the hash value. The private and public key pair may be generated based on an asymmetric cryptography technique, such as RSA.

FIG. 3C is a flow chart illustrating an example process 314 for verifying an electronic document based on a digital signature. In some implementations, the example process 314 includes the same, additional, and/or different operations in the same or a different order. In some cases, operations are implemented based on and/or to comply with the WS-Signature standard.

At 324, a comparison hash value is calculated based on the content document and the transformation document. The hash value may generated according to a hashing algorithm. The hash value may be calculated using the same technique as in operation 320 of FIG. 3B. At 326, a decrypted hash value is generated based on the encrypted hash value. The decrypted hash value may be generated based on a public key associated with a private key used to generate the encrypted hash value. At 328, the decrypted hash value and the comparison hash value are compared. In some cases, the content document and/or other data is verified based on the comparison of the comparison hash value and the decrypted hash value. In some cases, when the two compared hash values are identical, a message is considered authentic.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

FIG. 4 is a block diagram illustrating an example data processing system 400 in which digital signatures can be generated and/or authenticated. The data processing system 400 includes a central processor 410, which executes programs, performs data manipulations, and controls tasks in the system 400. The central processor 410 is coupled with a bus 415 that can include multiple busses, which may be parallel and/or serial busses.

The data processing system 400 includes a memory 420, which can be volatile and/or non-volatile memory, and is coupled with the communications bus 415. The system 400 can also include one or more cache memories. The data processing system 400 can include a storage device 430 for accessing a storage medium 435, which may be removable, read-only, or read/write media and may be magnetic-based, optical-based, semiconductor-based media, or a combination of these. The data processing system 400 can also include one or more peripheral devices 440(1)-440(n) (collectively, devices 440), and one or more controllers and/or adapters for providing interface functions.

The system 400 can further include a communication interface 450, which allows software and data to be transferred, in the form of signals 454 over a channel 452, between the system 400 and external devices, networks, or information sources. The signals 454 can embody instructions for causing the system 400 to perform operations. The system 400 represents a programmable machine, and can include various devices such as embedded controllers, Programmable Logic Devices (PLDs), Application Specific Integrated Circuits (ASICs), and the like. Machine instructions (also known as programs, software, software applications or code) can be stored in the machine 400 and/or delivered to the machine 400 over a communication interface. These instructions, when executed, enable the machine 400 to perform the features and functions described above. These instructions represent controllers of the machine 400 and can be implemented in a high-level procedural and/or object-oriented programming language, and/or in assembly/machine language. Such languages can be compiled and/or interpreted languages.

A number of implementations have been described. Nevertheless, it will be understood that various modifications may be made. Accordingly, other implementations are within the scope of the following claims.

What is claimed is:

1. A method of verifying an electronic document, the method comprising:
generating a display document based on a content document and a transformation document, the content document comprising content data, the transformation document comprising format data, the display document comprising information adapted to generate a graphical representation of the content data formatted according to the format data;
generating a digital signature using data from the content document and the transformation document; and
storing the digital signature.

2. The method of claim 1, further comprising:
receiving a modification of the content data; and
updating the content document based on the received modification of the content data, wherein generating a digital signature comprises generating a digital signature based on the updated content document and the transformation document.

3. The method of claim 1, further comprising:
generating the graphical representation; and
presenting the graphical representation to a user.

4. The method of claim 1, wherein the format data relate to at least one of a font size, a font style, a font color, a font position, or a font language.

5. The method of claim 1, wherein generating a digital signature comprises calculating a hash value based at least in part on the content document.

6. The method of claim 5, wherein generating a digital signature further comprises generating an encrypted hash value based at least in part on the calculated hash value.

7. The method of claim 6, further comprising:
generating a decrypted hash value based at least in part on the encrypted hash value;
calculating a verification hash value based at least in part on the content document; and
verifying at least the content document based on a comparison of the verification hash value and the decrypted hash value.

8. The method of claim 7, wherein the encrypted hash value is generated based on a private key and the decrypted hash value is generated based on a public key associated with the private key.

9. The method of claim 1, wherein generating a digital signature using data from the content document and the transformation document comprises calculating a hash value based at least in part on an identification of the transformation document.

10. The method of claim 1, wherein generating a digital signature using data from the content document and the transformation document comprises:
modifying the content document to include an identification of the transformation document; and
generating the digital signature based on the modified content document.

11. The method of claim 1, wherein generating a digital signature using data from the content document and the transformation document comprises generating a single digital signature based on the content data and the format data.

12. The method of claim 1, further comprising:
modifying the content document to include the digital signature; and
transmitting the modified content document over a communication interface.

13. A computer program product, tangibly stored on a computer-readable medium, comprising instructions operable to cause a programmable processor to:
generate a display document based on a content document and a transformation document, the content document comprising content data, the transformation document comprising format data, and the display document comprising information for generating a graphical representation of the content data formatted according to the format data; and
obtain a digital signature based on the content document and the transformation document.

14. The computer program product of claim 13, wherein the content document comprises an extensible markup language (XML) document and the transformation document comprises an extensible stylesheet language transformation (XSLT) document.

15. The computer program product of claim 13, wherein the display document comprises at least one of a portable document file (PDF) document or a hypertext markup language (HTML) document.

16. The computer program product of claim 13, wherein the instructions operable to generate a digital signature based on the content document and the transformation document comprise instructions operable to generate a digital signature based on the content data and at least one of the format data or an identification of the transformation document.

17. A system for verifying an electronic document, the system comprising:
a memory adapted to store:
a content document defining content data; and
a transformation document defining format data; and
a processor adapted to:
generate a display document based on the content document and the transformation document, the display document defining a graphical representation of the content data having an appearance based on the format data; and
generate a digital signature based on the content document and the transformation document.

18. The system of claim 17, further comprising a graphical user interface, wherein the processor is further adapted to present the graphical representation to a user using the graphical user interface.

19. The system of claim 17, wherein the processor is further adapted to modify the content document based on data received from a user, and wherein the digital signature is generated based on the modified content document and the transformation document.

20. The system of claim 17, the transformation document comprising a first transformation document, the format data comprising first format data for presenting information in a first language, the display document comprising a first display document, the memory further adapted to store a second transformation document for presenting information in a second language, the processor further adapted to generate a second display document based on the content document and the second transformation document.
